(19) United States
(12) Patent Application Publication
(10) Pub. No.: US 2025/0326198 A1
(43) Pub. Date: Oct. 23, 2025

(54) SQUEEZABLE HIGH BARRIER POLYOLEFIN TUBES

(71) Applicant: Kuraray Co., Ltd., Okayama (JP)

(72) Inventors: Frank BALEMANS, Melsele (BE); Masahiro KITAMURA, Chiyoda-ku, Tokyo (JP)

(73) Assignee: Kuraray Co., Ltd., Okayama (JP)

(21) Appl. No.: 18/869,155

(22) PCT Filed: Mar. 28, 2023
(86) PCT No.: PCT/JP2023/012520

§ 371 Date: Nov. 25, 2024

(30) Foreign Application Priority Data
May 27, 2022 (JP) 2022-087072

(51) Int. Cl. B32B 1/08; B32B 7/12; B32B 27/08; B32B 27/30; B32B 27/32

(52) U.S. Cl. CPC B32B 1/08; B32B 7/12; B32B 27/08; B32B 27/306; B32B 27/32; B32B 2255/10; B32B 2255/205; B32B 2307/308; B32B 2307/516; B32B 2307/518; B32B 2307/7244; B32B 2307/7376; B32B 2439/70; B32B 2439/80; B32B 2597/00

(57) ABSTRACT

Provided is a plastic tube comprising a body (A) and a shoulder (B), wherein a body (A) is a plastic film laminate with a total thickness of 200 to 500 μm comprising a multilayer film (A1) comprising an EVOH layer (a1) which is metalized or inorganic oxide coated on one surface and has a thickness of equal to or below 5 μm, a polyolefin layer (a2), and an adhesive layer (a3) between the surface of the EVOH layer (a1) which is not metalized or inorganic oxide coated and the polyolefin layer (a2), and a polyolefin film (A2) laminated to the metalized or inorganic oxide coated surface of the EVOH layer (a1). The plastic tube has improved oxygen and/or water barrier properties, improved mechanical strength as well as improved resistance to environmental factors such as repeated squeezing and/or twisting.

### TECHNICAL FIELD

The present invention relates to plastic tubes comprising metallized or inorganic oxide coated EVOH with high barrier properties for both moisture and oxygen.

### BACKGROUND ART

Squeezable tubes can be used for a variety of packaging solutions in industries like pharmaceuticals, cosmetics or food. They generally contain viscous liquids such as toothpaste, sauces or ointments. Basically, a tube is a cylindrical, hollow piece consisting of a tube body and a shoulder. Historically, such tubes have been made of metal and still now, many tubes comprise rather thick aluminum layers for their good barrier properties.

However, the industry is striving towards replacing the energy-intensive aluminum with recyclable polymers as much as possible. Ethylene vinyl alcohol (EVOH) is known as an excellent barrier material for different gases, including oxygen. Consequently, multilayer structures including a layer comprising EVOH, such as laminates with comprising the layers of polyethylene/EVOH/polyethylene, have already been described as barrier material for plastic tubes (for example PTL 1). However, their moisture barrier properties are not sufficient for certain applications.

PTL 2 describes a resin composition comprising an ethylene-vinyl alcohol copolymer and an unsaturated aldehyde, wherein the content of the unsaturated aldehyde is 0.01 ppm or more and 100 ppm or less. The preferable unsaturated aldehydes used therein are crotonaldehyde, 2,4-hexadienal and 2,4,6-octatrienal. By containing such unsaturated aldehydes, the resin composition is capable of obtaining melt molded articles that are superior in appearance with suppressed occurrences of defects such as fish eyes and streaks. However, there is no description about squeezable tube. Furthermore, there is no description about oxygen transmission rate (OTR) of the resin composition.

### CITATION LIST

### Patent Literature

PTL 1: JP 2014-97629 A
PTL 2: WO 2013/146961 A1

### SUMMARY OF INVENTION

### Technical Problem

To solve the above problems, an objective of the present invention is to provide plastic tubes with improved oxygen and/or water barrier properties, improved cost, improved mechanical strength as well as improved resistance to environmental factors such as repeated squeezing and/or twisting.

### Solution to Problem

Surprisingly, the current inventors have now found that a combination of metallized or inorganic oxide coated EVOH sandwiched by polyolefin films can be used to replace aluminum foil containing tubes and lead to plastic tubes with improved properties. Based on these surprising findings, these and other problems have been solved by the present invention.

In a first aspect, the present invention concerns a plastic tube comprising a body (A) and a shoulder (B), wherein
a. body (A) is a plastic film laminate with a total thickness of 200 to 500 μm comprising
i. a multilayer film (A1) comprising
1. an EVOH layer (a1) which is metalized or inorganic oxide coated on one surface,
2. a polyolefin layer (a2),
3. an adhesive layer (a3) between the surface of the EVOH layer (a1) which is not metalized or inorganic oxide coated and the polyolefin layer (a2), and
ii. a polyolefin film (A2) laminated to the metalized or inorganic oxide coated surface of the EVOH layer (a1), and wherein
b. the ethylene content of the EVOH in the EVOH layer (a1) is from 20 to 50 mol %,
c. the EVOH layer (a1) has a thickness of equal to or below 5 μm, and
d. the body (A) has an Oxygen Transmission Rate measured at 23° C. and 50% RH according to ISO21309-2 Annex C of below 0.5 cc/m², day, atm.

In the plastic tube, it is preferable that the multilayer film (A1) is uniaxially oriented with a stretching ratio of equal to or above 3. It is also preferable that the multilayer film (A1) is biaxially oriented with a stretching ratio of equal to or above 3 in both machine direction and transverse direction. It is also preferable that the melting point of the EVOH layer (a1) is equal to or below 150° C.

In the plastic tube, the EVOH layer (a1) preferably comprises crotonaldehyde (X1) and 2,4-hexadienal (X2), and the content x1 of crotonaldehyde (X1) in the EVOH layer (a1) is 0.01 ppm or more and 4.0 ppm or less, and the content x2 of 2,4-hexadienal (X2) in the EVOH layer (a1) is 0.005 ppm or more and 0.65 ppm or less.

It is more preferable that the EVOH layer (a1) optionally comprises 2,4,6-octatrienal (X3), and the sum (x1+x2+x3) is 7.0 ppm or less, wherein (x1) is the amount in ppm of crotonaldehyde (X1) in the EVOH layer (a1), (x2) is the amount in ppm of 2,4-hexadienal (X2) in the EVOH layer (a1), and (x3) is the amount in ppm of 2,4,6-octatrienal (X3) in the EVOH layer (a1).

It is also more preferable that x1/(x2+x3) is 2.0 or more and 150.0 or less. It is also more preferable that the sum (x2+2x3) of the content x2 (ppm) of 2,4-hexadienal (X2) and the content x3 (ppm) of 2,4,6-octatrienal (X3) by twice the content x3 (ppm) is 0.65 ppm or less.

In the plastic tube, the body (A) preferably comprises a polyolefin layer (a5) comprising a post-consumer recycled polyolefin sandwiched between the polyolefin layer (a2) and an additional EVOH layer (a4). It is also preferable that the multilayer structure (A1) is prepared by co-extrusion of the separate layers (a1) to (a3) and optional (a4) and (a5). It is also preferable that the shoulder (B) is a multilayer structure comprising an EVOH layer (b1) sandwiched between two polyolefin layers (b2) and (b3). It is also preferable that the shoulder (B) is a multilayer structure comprising adhesive layers between EVOH layer (b1) and polyolefin layer (b2) as well as between EVOH layer (b1) and polyolefin layer (b3).

Preferable embodiment is use of the above-mentioned plastic tube in food, cosmetic or medical packaging applications.

### Advantageous Effects of Invention

The plastic tubes of the present invention have improved oxygen and/or water barrier properties, improved cost, improved mechanical strength as well as improved resistance to environmental factors such as repeated squeezing and/or twisting.

### DESCRIPTION OF EMBODIMENTS

The EVOH as used herein comprises ethylene and vinyl alcohol units as principal structural units. It may include one type or a plurality of types of other structural units in addition to the ethylene unit and the vinyl alcohol unit.

EVOH is usually obtained by co-polymerization of ethylene and vinyl acetate, followed by a saponification process of the resultant ethylene-vinyl acetate copolymer.

The lower limit of the content of ethylene units, i.e., the proportion of the number of ethylene units relative to the total number of monomer units in EVOH, is preferably 3 mol %, more preferably 10 mol % and still more preferably 20 mol %. On the other hand, the upper limit of the content of ethylene units is preferably 70 mol %, more preferably 60 mol %, still more preferably 55 mol %, and particularly preferably 50 mol %. Also preferably, the ethylene content is between 20 and 50 mol %.

Preferably, the lower limit of the saponification degree of the EVOH, i.e., the proportion of the number of vinyl alcohol units relative to the total number of vinyl alcohol units and vinyl acetate units in the EVOH, is preferably 80 mol %, more preferably 95 mol %, and particularly preferably 99 mol %.

The EVOH layer preferably contains a compound such as acids and/or metal ions to improve thermal stability and to adjust the viscosity. Examples of suitable compounds include alkali metal salts, carboxylic acid, phosphoric acid compounds and boron compounds. These compounds can be used as a premix with EVOH.

Suitable alkali metal salts include sodium acetate, potassium acetate, sodium phosphate, lithium phosphate, sodium stearate, potassium stearate, sodium ethylenediamine tetraacetate. Carboxylic acids include oxalic acid, succinic acid, benzoic acid, citric acid, acetic acid, lactic acid. Phosphoric acid compounds include various acids such as phosphoric acid and phosphorous acid, their salts. Boron compounds include boric acids, boric acid esters, boric acid salts, borohydrates.

The EVOH layer may contain other additives such as heat stabilizers, ultraviolet ray absorbing agents, antioxidants, plasticizers, antistatic agents, lubricants, colorants and fillers in the range not to impair the object of the present invention. When the EVOH layer contains such additives, the amount is preferably no greater than 10% by mass, more preferably no greater than 5% by mass, and particularly preferably no greater than 3% by mass with respect to the total mass of the EVOH layer.

Suitable antioxidants as used herein are materials which inhibit oxidative degradation or cross-linking of EVOH and include 2,5-di-t-butylhydroquinone, 2,6-di-t-butyl-p-cresol, 4,4′-thiobis-(6-t-butylphenol), 2,2′-methylenebis-(4-methyl-6-t-butylphenol), octadecyl-3-(3′,5′-di-t-butyl-4′-hydroxyphenyl) propionate, 4,4′-thiobis-(6-t-butylphenol), tetrakis(3-(3,5-di-tert-butyl-4-hydroxyphenyl) propionate), 3,3′-bis(3,5-di-tert-butyl-4-hydroxyphenyl)-N,N′-hexamethylenedipropionamide.

Suitable plasticizers include diethyl phthalate, dibutyl phthalate, dioctyl phthalate, wax, liquid paraffin, phosphoric acid esters and the like.

Suitable ultraviolet ray absorbing agents include ethylene-2-cyano-3,3′-diphenyl acrylate, 2-(2′-hydroxy-5′-methylphenyl)benzotriazole, 2-(2′-hydroxy-5′-methylphenyl)benzotriazole, 2-(2′-hydroxy-5′-methylphenyl)benzotriazole, 2-(2′-hydroxy-3′-t-butyl-5′-methylphenyl) 5-chlorobenzotriazole, 2-hydroxy-4-methoxybenzophenone, 2,2′-dihydroxy-4-methoxybenzophenone and the like.

Suitable antistatic agents include pentaerythritol monostearate, sorbitan monopalmitate, sulfated polyolefins, polyethylene oxides and the like.

Suitable lubricants include ethylenebis (stearic acid amide), butyl stearate and the like.

The EVOH layers of the present invention have a thickness of equal to or below 5 μm, preferably equal to or below 3 μm, more preferably equal to or below 2 μm. Even if the thickness of the EVOH layer is very small, the tube body has low oxygen transmission rate (OTR) and low water vapor transmission rate (WVTR). This is because the EVOH layer is metalized or inorganic oxide coated on its surface. When the thickness of the EVOH layer is very small, the mass ratio of the EVOH in the tube body becomes very small. Then, the tube body can be recycled and used together with polyolefins. Not only barrier properties but also recyclability can be improved by the thin EVOH layer. The thickness of the EVOH layer preferably have a thickness of equal to or above 0.5 μm.

“Thickness” as used herein shall denote the average thickness of the individual layers after preparation of the multilayer structure.

The EVOH layer (a1) is metalized or inorganic oxide coated on at least one surface.

Metal coating is preferred when light shielding is required. When the surface is metalized, metallization with aluminum is most preferred. The content of metal atoms in the metal coating is preferably 50 mol % or more, more preferably 70 mol % or more, still more preferably 90 mol % or more, and particularly preferably 95 mol % or more.

Inorganic oxide coating is usually preferred when the contents of the plastic tube should be visible. Suitable inorganic oxide coatings include coatings comprising oxides of silicon, aluminum, magnesium, calcium, potassium, tin, sodium, boron, titanium, lead, zirconium, yttrium, and mixtures thereof. Preferably, they comprise a vapor deposition film of alumina or silica aluminum oxide, magnesium oxide, silicon oxide or mixtures thereof. Metal oxynitrides are also suitable.

Since the EVOH film has good affinity to the metallization or inorganic oxide coating, the barrier properties of the film are maintained even when subjected to physical stress such as twisting and squeezing.

The metallization or inorganic oxide coating can be deposited by known physical or chemical deposition methods. Specifically, a vacuum deposition method, a sputtering method, an ion plating method, an ion beam mixing method, a plasma CVD method, a laser CVD method, a MO-CVD method, and a thermal CVD method. Preferably, a physical vapor deposition method is used. Prior to deposition, the EVOH surface may be plasma-treated. The plasma treatment may be a known method, and atmospheric pressure plasma treatment is preferred. In the atmospheric pressure plasma treatment, nitrogen, helium, neon, argon, krypton, xenon, radon, and the like are used as discharge gases. Of these, nitrogen, helium, and argon are preferably used, and nitrogen is particularly preferred because the cost can be reduced.

The thickness of the metal or inorganic oxide layer is preferably less than 150 nm, more preferably less than 100 nm, even more preferably less than 50 nm and most preferably less than 25 nm. The thickness of the metal or inorganic oxide layer is preferably more than 1 nm, more preferably more than 5 nm.

The body (A) has a total thickness of 200 to 500 μm, preferably 225 to 450 μm, and more preferably 250 to 400 μm.

In a preferred embodiment, the multilayer film (A1) is uniaxially oriented with a stretching ratio of equal to or above 3. Also preferably, the stretching ratio is equal to or less than 12. More preferably, it is stretched more than 4, even more preferably more than 5 times. Also preferably, it is stretched in the machine direction.

In another preferred embodiment, the multilayer film (A1) is biaxially oriented with a stretching ratio of equal to or above 3 in both machine direction and transverse direction. Biaxial stretching may be either sequential biaxial stretching or simultaneous biaxial stretching. The lower limit of the stretching ratio in terms of area is more preferably 6 times, most preferably 8 times. The upper limit of the stretching ratio is 50 times, more preferably 45 times. When the stretching ratio is in the above range, the thickness uniformity, gas barrier properties and mechanical strength of the monolayer film are improved. Further, the stretching temperature may be, for example, 80° C. or more and 170° C. or less.

The method of stretching is not particularly limited, and for example, a tender stretching method, a tubular stretching method, or a roll stretching method is used. From the viewpoint of manufacturing cost, uniaxial stretching by a roll stretching method is preferred.

Also preferably, in the case of sequential biaxial stretching of polyethylene and EVOH based multilayer film, the melting point of the EVOH layer (a1) is equal to or below 150° C., more preferably equal to or below 140° C. and most preferably equal to or below 130° C.

The lower limit of the content x1 of crotonaldehyde (X1) in the EVOH layer (a1) is preferably 0.01 ppm, more preferably 0.10 ppm, still more preferably 0.20 ppm, and even more preferably 0.40 ppm. On the other hand, the upper limit is 4.0 ppm preferred, 3.5 ppm more preferred, 2.7 ppm more preferred, and especially 1.5 ppm.

Additionally, the lower limit of the content x2 of the 2,4-hexadienal (X2) in the EVOH layer (a1) is preferably 0.005 ppm, more preferably 0.01 ppm, and still more preferably 0.02 ppm. On the other hand, the upper limit is preferably 0.65 ppm, more preferably 0.20 ppm, still more preferably 0.10 ppm, still more preferably 0.08 ppm, and particularly 0.06 ppm.

In the present invention, it is preferable that the content x1 of crotonaldehyde (X1) and the content x2 of the 2,4-hexadienal (X2) in the EVOH layer (a1) are in the ranges mentioned above. Then, the tube body has small OTR value and WVTR value even if the tube body is folded. While melt molding of the films containing EVOH layer, die-buildup decreases by adding crotonaldehyde (X1) and 2,4-hexadienal (X2) in the EVOH resin. Therefore, it seems that the metalized or inorganic oxide coated layer can be stably adhered to the EVOH surface.

The upper limit of the content x3 of the 2,4,6-octatrienal (X3) in the EVOH layer (a1) is preferably 0.325 ppm, more preferably 0.23 ppm, still more preferably 0.07 ppm, and particularly preferably 0.04 ppm. The lower limit of the content X3 is 0 ppm, more preferably 0.005 ppm.

The EVOH layer (a1) may optionally comprise 2,4,6-octatrienal (X3). Preferably the upper limit of the sum (x1+x2+x3) is 7.0 ppm, more preferably 4.0 ppm and particularly 1.0 ppm. If the sum (x1+x2+x3) is more than 7.0 ppm, OTR value and WVTR value increase and odor generates. The lower limit of x1+x2+x3 is preferably 0.01 ppm, more preferably 0.10 ppm and most preferably 0.50 ppm.

The lower limit of x1/(x2+x3) is preferably 4.0, more preferably 8.0. On the other hand, the upper limit of x1/(x2+x3) is preferably 60.0, more preferably 25.0, and most preferably 13.0. If the value x1/(x2+x3) is less than the lower limit, the unevenness in thickness of the EVOH layer (a1) in the multilayer structure of the tube body tends to be large. As a result, the OTRs of the tube bodies before and after the folding tests tend to be large, and the odor evaluation tends to deteriorate. These effects cannot be found when only one compound X1, X2 or X3 is used.

The upper limit of the sum (x2+2x3) of the content x2 (ppm) of 2,4-hexadienal (X2) and the content x3 (ppm) of 2,4,6-octatrienal (X3) by twice the content x3 (ppm) is not more than 0.65 ppm, with 0.50 ppm preferred, 0.30 ppm more preferred, and 0.10 ppm most preferred. If the sum (x2+2x3) is too large, the appearance of the tube tends to deteriorate.

Also preferably, the EVOH layer (a1) in the multilayer film (A1) comprises crotonaldehyde (X1) and either 2,4-hexadienal (X2) or 2,4,6-octatrienal (X3), and satisfies the following equations (1) and (2)

$$2. ≦ ( x 1 ) / ( ( x 2 ) + ( x 3 ) ) < 150.0 \qquad ( 1 )$$

$$( x 2 ) + 2 \times ( x 3 ) ≦ 0.65 \qquad ( 2 )$$

wherein in the above equations (1) and (2), (x1) is the amount in ppm of crotonaldehyde (X1) in the EVOH layer (a1), (x2) is the amount in ppm of 2,4-hexadienal (X2) in the EVOH layer (a1), and (x3) is the amount in ppm of 2,4,6-octatrienal (B3) in the EVOH layer (a1). If the equation (1) or (2) is not satisfied, the OTRs of the tube bodies before and after the folding tests tend to be large, the odor evaluation deteriorates, and the appearance of the tube tends to deteriorate.

Adhesive layers (a3) are known in the art and can incorporate some polar functionality to promote compatibility with a polar material and some non-polar functionality to maintain compatibility with a non-polar layer. Examples of useful materials for such bonding layers include anhydride modified polyolefins, e.g. maleic anhydride-grafted polypropylenes and polyethylenes, such as Bynel (registered trademark) 40E529 available from DuPont, and ethylene polar terpolymers such as LOTADER (trademark) available from Arkema.

Preferably, the thickness of the adhesive layer is equal to or below 20 μm, more preferably equal to or below 10 μm. On the other hand, the thickness is preferably equal to or above 1 μm. Also preferably, the thickness of the adhesive layer is from 1 μm to 10 μm.

Polyolefin layers according to the present invention can be independently selected from layers comprising polyethylene (PE), especially high-density polyethylene (HDPE) or low-density polyethylene (LDPE), linear low-density polyethylene, (LLDPE) and polypropylene (PP).

It is also preferred to use at least some degree of recycled polyolefin in the body (A) in order to meet environmental concerns as well as to avoid taxation. For example, some European countries apply tax to packaging material with a content of recycled material below 30%.

However, safety issues due to migration of contaminants and/or odor issues from the recycled material are of concern when recycled polyolefin resin is used in common tubes. It has now been found that body (A) of the present invention can solve these issues and blocks migration of contaminants as well as unpleasant odors.

Thus, another preferred embodiment concerns a body (A) which comprises a polyolefin layer (a5) comprising a post-consumer or post-industrial recycled polyolefin, between the polyolefin layer (a2) and an additional EVOH layer (a4).

The method for producing the inventive body (A) or multilayer films (A1) is not particularly limited as long as the method can favorably laminate and adhere the individual layers, and any of the known methods such as coextrusion, pasting, coating, bonding, and attaching may be employed.

Preferably, the multilayer structure (A1) is prepared by lamination of a co-extruded film comprising (a1) to (a3) and a co-extruded film comprising (a4) and (a5).

Alternatively, the multilayer structure (A1) is prepared by lamination of a co-extruded film comprising (a1) to (a3), a film comprising (a4), and a film comprising (a5).

Yet another aspect of the present invention concerns the use of a plastic tube according to the present invention in food, cosmetic or medical packaging applications.

### EXAMPLES

### Example 1

### Preparation of EVOH1

2 kg of ethylene vinyl alcohol copolymer with 32 mol % ethylene content, fully saponified, commercially available from EVAL Europe N.V. with a melt index of 1.6 g/10 min (at 190° C., 2.16 kg load), density: 1.19 g/cm³, 0.8 kg of water and 2.2 kg of MeOH are added in a 60 L sized tank equipped with a jacket, stirrer and reflux cooler. The mixture is stirred at 60° C. for 5 hours to dissolve completely. To the obtained solution, crotonaldehyde is added. The amount of crotonaldehyde is adjusted to be as described in Table 5. The solution is passed through a 4 mm diameter nozzle and coagulated in a water/MeOH=90/10 mixture at −5° C. to make strands. The strands are cut into pellets using a strand cutter to obtain unwashed pellets of EVOH containing water. The resulting pellets of EVOH are placed in ion-exchanged water (bath ratio 20), and stirred for 2 hours and remove the water in order to wash the pellets of EVOH. The process is repeated three times to obtain washed pellets of EVOH. The moisture content of the obtained EVOH pellets is 52 wt % measured by a Mettler halogen moisture tester HR73.

The obtained pellets are put in aqueous solution containing sodium acetate concentration 0.510 g/L, acetic acid concentration of 0.8 g/L, and phosphoric acid concentration 0.04 g/L (bath ratio 20) and then immersed for 4 hours with periodic stirring. Then the pellets are dewatered and dried under nitrogen with oxygen concentration less than 1 volume percent at 80° C. for 3 hour and at 105° C. for 16 hours. As a result, dried EVOH pellets (EVOH1 pellets) with acetic acid, phosphoric acid, sodium ion (sodium salt), crotonaldehyde are prepared. It is cylindrical pellet with average diameter 2.8 mm and average height 3.2 mm. The composition of dried pellets is evaluated. The sodium ion content in the dried resin composition pellets was 100 ppm, and the phosphoric acid content was 40 ppm and acetic acid content is 200 ppm. The contents of crotonaldehyde, 2,4-hexadienal and 2,4,6-octatrienal in EVOH1 pellets are shown in Table 5. The measurement method for the contents of these aldehydes is explained below.

### Measurement of crotonaldehyde, 2,4-hexadienal and 2,4,6-octatrienal in EVOH1 pellet

Dried EVOH1 pellets are grinded by freezing and pulverizing, then weighed 50.0 mg into a glass tube for a heat-desorbable gas chromatograph mass spectrometer to prepare a sample tube. Using the following heat desorption gas chromatograph mass analyzer, heat the sample under the following conditions to adsorb the entire amount of volatile gas from the sample to the adsorption tube, and then separate the re-emitted gas from the adsorption tube by a column. Peaks for each component are detected. A calibration curve is prepared from the peak areas of standard samples of crotonaldehyde, 2,4-hexadienal and 2,4,6-octatrienal, and each was quantified by the absolute calibration curve method. When measuring the standard sample, a suction tube (Tenax (registered trademark)/Carboxen (registered trademark)) is impregnated with the standard sample, and a suction tube impregnated with the standard sample is used instead of the sample tube. The temperature at the time of discharge after adsorption is measured by the same method as in the case of measuring the sample tube, except that the temperature of the sample tube is changed from 170° C. to the temperature of the adsorption tube at 260° C.
(Heat desorption part) Equipment: TurboMatrix-ATD (manufactured by Perkin Elmer Japan)
Temperature when sample is adsorbed to the adsorption tube: 170° C. (sample tube), −30° C. (adsorption tube), 250° C. (valve), 260° C. (transfer line)
Adsorption time to adsorption tube: 10 minutes
Temperature at the time of release after sample adsorption: 170° C. (sample tube), 260° C. (adsorption tube), 250° C. (valve), 260° C. (transfer line)
Suction tube release time: 35 minutes
Carrier gas: Flow rate of carrier gas to helium column: 1.0 ml/min
Pressure: 120 kPa (Gas chromatograph mass spectrometer)
Equipment: 7890B GC System, 7977B MSD (manufactured by Agilent Technologies)
Column: DB-WAX UI (length: 30 m, inner diameter: 0.25 mm, film thickness: 0.50 μm)
Column oven temperature: After holding for 5 minutes at 40° C., hold for 10 minutes after adjusting the temperature to 240° C. at a heating rate of 10° C./min (total measurement temperature 35 minutes)
Transfer line (connection) temperature: 240° C.
Ionization conditions: EI+Detected ion mass range: m/z=29-600
Detection method: SCAN (Standard sample)
Crotonaldehyde: made by Aldrich
2,4-Hexadienal: made by Aldrich
2,4,6-Octatrienal: made by Nard Institute

A 3-layer barrier film is prepared on a Collin cast coextrusion line with PE, adhesive resin (Adh) and EVOH with following thicknesses:

$$PE 1 / Adh 1 / EVOH 1 = 19 / 3 / 3 μm$$

PE1: Lumicene (trademark) Supertough 40ST05 commercially available from Total with a melt index of 0.5 g/10 min (at 190° C., 2.16 kg load)
Adh1: Maleic anhydride modified polyethylene Admer (trademark) NF528 commercially available from Mitsui Chemicals Inc with a melt index of 2.5 g/10 min (at 190° C., 2.16 kg load)

The EVOH surface of above 3-layer film is metalized with aluminum and the optical density is 3.0.

A 3-layer PE film is prepared on a Collin cast coextrusion line with following PE resins and the thickness is as follows.

$$PE 2 / PE 3 / PE 2 = 30 / 60 / 30 μm$$

PE2: Dowlex209 commercially available from Dow chemical with density 0.926 g/cm³
PE3: Hizex 3300F commercially available from Prime Polymer with density 0.950 g/cm³

Both sides of the metalized 3-layer barrier film are laminated with the 3-layer PE film by applying polyurethan based adhesive (Takelac A-520 and Takenate A-50, with 2 μm thickness after drying)

The laminated film is made into cylinder shape by heat sealing in order to form a tube body with 50 mm diameter and 158 mm length, and jointed with tube shoulder prepared by common compression molding process with PE4.
PE4: Purell ACP 6541A commercially available from LyondellBasell with a melt index of 1.45 g/10 min (at 190° C., 2.16 kg load), density: 0.954 g/cm³

The averaged tube shoulder thickness is 1.1 mm, and the shoulder surface area is 19 cm².

In a final step, the bottom part of tube is heat sealed.

### Oxygen Transmission Rate Measurement:

The oxygen transmission rate of tube body part only and tube itself is respectively measured at 23° C. and 50% RH according to ISO21309-2 Annex C.

### Water Vapor Transmission Rate Measurement:

Water vapor transmission rate of tube is measured at 38° C. 90% RH according to ASTM F1249.

### Folding Test of Tube:

The tube body part and shoulder part are separated using a cutter, and the body part is cut into a flat sheet (10 cm×10 cm). The flat sheet is folded 180° by hand at both vertical and horizontal direction, followed by oxygen transmission rate measurement.

### Odor Evaluation:

The tube is put into a glass vessel and closed with a metal cap. After storing for 7 days at 40° C., the smell in the glass vessel is detected by panelist. Evaluation: (low smell) A<B (strong smell)

### Appearance of Tube Body:

The appearance of tube body is evaluated by eye
Evaluation: (Good) A<B<C (poor);
A: no visible defect on the tube body
B: slight line on the tube body
C: clear visible line on the tube body

The test results and layer thicknesses of examples 2 to 7 and reference 1 to 2 are summarized in Table 1 and 2.

### Example 2

A 3-layer barrier film is prepared on a Collin cast coextrusion line of PE, adhesive resin (Adh) and EVOH with following thicknesses:

$$PE 1 / Adh 1 / EVOH 1 = 95 / 15 / 15 μm$$

And the 3-layer barrier film is uniaxially oriented (Machine direction) at 120° C. with stretching ratio 5. After the orientation, the thickness is PE1/Adh1/EVOH1=19/3/3 μm

Except above 3-layer barrier film preparation, the same procedure as described in Example 1 is repeated.

### Example 3

A 3-layer barrier film is prepared on a Collin cast coextrusion line of PE, adhesive resin (Adh) and EVOH with following thicknesses:

$$PE 5 / Adh 1 / EVOH 2 = 352 / 32 / 16 μm$$

PE5: Innate (trademark) TF80 commercially available from Dow Chemical with melting point 122° C.
EVOH2: epoxypropane modified EVOH with 44 mol ethylene content prepared by following process:

28 parts by weight of zinc acetylacetonate monohydrate is mixed with 957 parts by weight of 1,2-dimethoxyethane to obtain a mixed solution. To the obtained mixed solution, 15 parts by weight of trifluoromethanesulfonic acid is added with stirring to obtain a catalyst solution. Next, an EVOH with an ethylene unit content of 44.0 mol % and a saponification degree of 99.9 mol % or more is used in a TEM-35BS extruder manufactured by Toshiba Machine Co., Ltd. (37 mmφ, L/D=52.5), and the barrels C1 were water-cooled, the barrels C2 to C3 were operated at 200° C., the barrels C4 to C15 were operated at 240° C., and the screw rotation speed is 250 rpm. Epoxy propane (1.5 kg/hr) and the above catalyst solution were added from the inlet 1 at C8. Then, an aqueous solution of sodium acetate and potassium acetate is added from the inlet 2 at C13. The discharged strands were cooled and solidified in a cooling bath and then cut to obtain the pellets. In this step, the amount of the catalyst solution added is adjusted so that the melting point of the modified EVOH is 119° C.

Afterwards, the 3-layer barrier film is biaxially oriented at 125° C. by tenter flame sequential orientation process, with a stretching ratio of 4 at the machine direction and 4 at the transverse direction, respectively. After the orientation, the thickness is

$$PE 1 / Adh 1 / EVOH 2 = 22 / 2 / 1 μm .$$

Except the above 3-layer barrier film preparation, the same procedure as described in Example 1 is repeated.

### Example 4

### Preparation of EVOH3

EVOH3 pellets are prepared in the same manner as in Example 1 except that the ethylene vinyl alcohol copolymer is changed to the one with 48 mol % ethylene content, fully saponified, commercially available from EVAL Europe N.V. with a melt index of 6.4 g/10 min (at 190° C., 2.16 kg load), density: 1.12 g/cm³. The contents of crotonaldehyde, 2,4-hexadienal and 2,4,6-octatrienal in EVOH3 pellets are shown in Table 5.

A 3-layer barrier film is prepared on a Collin cast coextrusion line of PP, adhesive resin (Adh) and EVOH with following thicknesses:

$$PP 1 / Adh 2 / EVOH 3 = 352 / 32 / 16 μm$$

PP1: Advanced-PP 1104K commercially available from Advanced Petrochemical Company with density 0.91 g/cm³.
Adh2: ADMER AT1179E commercially available from Mitsui Chemical Europe GmbH with density 0.91 g/cm³.

The 3-layer barrier film is biaxially oriented at 160° C. by tenter flame sequential orientation process, 4 times at the machine direction and 4 times at the transverse direction respectively. After the orientation, the thickness is PP1/Adh1/EVOH3=22/2/1 μm.

Except above 3-layer barrier film preparation, the same procedure as described in Example 1 is repeated.

### Example 5

Biaxially oriented 3-layer barrier film and 3-layer PE film are prepared by the same process as Example 3. And another 5-layer barrier film with Post Consumer Recycled PE is prepared on a Collin cast coextrusion line of PE resins, adhesive resin and EVOH with following thicknesses:

$$PE 6 / adh 1 / EVOH 1 / adh 1 / PE 2 = 85 / 5 / 5 / 5 / 20 μm$$

PE6: Post Consumer Recycled LDPE resin with grade name RYMO-W122 supplied by Morssinkhof Rymoplast, with a melt index of 0.6 g/10 min (at 190° C., 2.16 kg load) and density 0.92 g/cm³

The metalized surface of biaxially oriented 3-layer barrier film is laminated to 3-layer PE film, and PE surface of biaxially oriented 3-layer barrier film is laminated with PE6 layer of 5-layer barrier film.

Except above 5-layer barrier film, the same procedure as described in Example 3 is repeated.

### Example 6

Instead of 5-layer film of PE6/adh1/EVOH1/adh1/PE2 shown in Example 5, PE6/PE3/PE2 with thickness of 85/10/25 μm prepared on a Collin cast coextrusion line is used for lamination to PE surface of biaxially oriented 3-layer barrier film. Except above, the same procedure as described in Example 5 is repeated.

### Example 7

The tube body is prepared with the same procedure as Example 2, and jointed with tube shoulder prepared by 3-layer compression molding process with following structure, PE4+Adh1/EVOH1/PE4+Adh1. The blend of PE4 and Adh1 is 90/10 weight %. The averaged tube shoulder thickness is 1.1 mm, and EVOH layer thickness is 50 μm.

Except above tube shoulder, the same procedure as described in Example 3 is repeated.

### Example 8

A 3-layer barrier film is prepared on a Collin cast coextrusion line with PE, adhesive resin (Adh) and EVOH with following thicknesses:

$$PE 1 / Adh 1 / EVOH4 = 19 / 3 / 3 μm$$

Except EVOH4 is used instead of EVOH1, the same procedure as described in Example 1 is repeated.

### Preparation of EVOH4

EVOH4 pellets are prepared in the same manner as in Example 1 except that the amount of crotonaldehyde is changed and 2,4-hexadienal and 2,4,6-octatrienal are added together with crotonaldehyde. The contents of crotonaldehyde, 2,4-hexadienal and 2,4,6-octatrienal in EVOH4 pellets are shown in Table 5.

### Example 9

A 3-layer barrier film is prepared on a Collin cast coextrusion line of PE, adhesive resin (Adh) and EVOH with following thicknesses:

$$PE 1 / Adh 1 / EVOH4 = 95 / 15 / 15 μm$$

And the 3-layer barrier film is uniaxially oriented (Machine direction) at 120° C. with stretching ratio 5. After the orientation, the thickness is PE1/Adh1/EVOH4=19/3/3 μm

Except above 3-layer barrier film preparation, the same procedure as described in Example 1 is repeated.

### Example 10

A 3-layer barrier film is prepared on a Collin cast coextrusion line of PP, adhesive resin (Adh) and EVOH with following thicknesses:

$$PP 1 / Adh 2 / EVOH 5 = 352 / 32 / 16 μm$$

The 3-layer barrier film is biaxially oriented at 160° C. by tenter flame sequential orientation process, 4 times at the machine direction and 4 times at the transverse direction respectively. After the orientation, the thickness is PP1/Adh1/EVOH5=22/2/1 μm.

Except above 3-layer barrier film preparation, the same procedure as described in Example 4 is repeated

### Preparation of EVOH5

EVOH5 pellets are prepared in the same manner as EVOH3 pellets in Example 4 except that the amounts of crotonaldehyde, 2,4-hexadienal and 2,4,6-octatrienal are changed. The contents of crotonaldehyde, 2,4-hexadienal and 2,4,6-octatrienal in EVOH5 pellets are shown in Table 5.

### Example 11-17

EVOH6-12 pellets are prepared in the same manner as EVOH4 pellets in Example 8 except that the amounts of crotonaldehyde, 2,4-hexadienal and 2,4,6-octatrienal are changed. The contents of crotonaldehyde, 2,4-hexadienal and 2,4,6-octatrienal in EVOH6-12 pellets are shown in Table 5.

A 3-layer barrier film is prepared in the same manner as in Example 10 except that the EVOH pellets used are changed to EVOH6-12 pellets. Except above 3-layer barrier film preparation, the same procedure as described in Example 1 is repeated.

The test results and layer thicknesses of examples 8 to 17 are summarized in Table 3 and 4.

### Reference 1

Instead of 3-layer barrier film shown in Example 2, 5-layer barrier film is prepared on a Collin cast coextrusion line of PE, adhesive resin (Adh) and EVOH with following thicknesses:

$$PE 1 / Adh 1 / EVOH 1 / Adh 1 / PE 1 = 40 / 15 / 15 / 15 / 40 μm$$

And the 5-layer barrier film is uniaxially oriented (Machine direction) at 120° C. with stretching ratio 5. After the orientation, the thickness is PE1/Adh1/EVOH1/Adh1/PE1=8/3/3/3/8 μm.

The one side of PE surface of above uniaxially oriented 5-layer barrier film is metalized and the optical density is 3.0.

Except above 5-layer barrier film preparation, the same procedure as described in Example 2 is repeated.

### Reference 2

3-layer barrier film shown in Example 1 is not metalized and provided to lamination and tube making process.

Except above, the same procedure as described in Example 1 is repeated.

TABLE 1

| | | | | | Structure of body | | | | | | | |
|---|---|---|---|---|---|---|---|---|---|---|---|---|
| | | | | | Upper; material | | | | | | | |
| | | (outside) | | | Lower; thickness (micron) | | | | | | | |
| Example | 1 | PE2 | PE3 | PE2 | lamination | metalized | EVOH1 | adh1 | PE1 | | | lamination |
| | | 30 | 60 | 30 | | — | 3 | 3 | 19 | | | |
| | 2 | PE2 | PE3 | PE2 | lamination | metalized | EVOH1 | adh1 | PE1 | | | lamination |
| | | 30 | 60 | 30 | | uniaxially oriented | 3 | 3 | 19 | | | |
| | 3 | PE2 | PE3 | PE2 | lamination | metalized | EVOH2 | adh1 | PE5 | | | lamination |
| | | 30 | 60 | 30 | | biaxially oriented | 1 | 2 | 22 | | | |
| | 4 | PE2 | PE3 | PE2 | lamination | metalized | EVOH3 | adh2 | PP1 | | | lamination |
| | | 30 | 60 | 30 | | biaxially oriented | 1 | 2 | 22 | | | |
| | 5 | PE2 | PE3 | PE2 | lamination | metalized | EVOH2 | adh1 | PE5 | | | lamination |
| | | 30 | 60 | 30 | | biaxially oriented | 1 | 2 | 22 | | | |
| | 6 | PE2 | PE3 | PE2 | lamination | metalized | EVOH2 | adh1 | PE5 | | | lamination |
| | | 30 | 60 | 30 | | biaxially oriented | 1 | 2 | 22 | | | |
| | 7 | PE2 | PE3 | PE2 | lamination | metalized | EVOH2 | adh1 | PE5 | | | lamination |
| | | 30 | 60 | 30 | | biaxially oriented | 1 | 2 | 22 | | | |
| Reference | 1 | PE2 | PE3 | PE2 | lamination | metalized | PE1 | adh1 | EVOH1 | adh1 | PE1 | lamination |
| | | 30 | 60 | 30 | | uniaxially oriented! | 8 | 3 | 3 | 3 | 8 | |

| | | | | | | | | | |
|---|---|---|---|---|---|---|---|---|---|
| 2 | PE2 | PE3 | PE2 | lamination | — | EVOH1 | adh1 | PE1 | lamination |
| | 30 | 60 | 30 | | — | 3 | 3 | 19 | |

| | | | | | Strucutre of shoulder |
|---|---|---|---|---|---|
| | | | | | Upper; material |
| | | (inside) | | | Lower; thickness (micron) |
| Example | 1 | PE2 | PE3 | PE2 | PE4 |
| | | 30 | 60 | 30 | 1100 |
| | 2 | PE2 | PE3 | PE2 | PE4 |
| | | 30 | 60 | 30 | 1100 |
| | 3 | PE2 | PE3 | PE2 | PE4 |
| | | 30 | 60 | 30 | 1100 |
| | 4 | PE2 | PE3 | PE2 | PE4 |
| | | 30 | 60 | 30 | 1100 |

| | | | | | | |
|---|---|---|---|---|---|---|
| 5 | PE6 | adh1 | EVOH1 | adh1 | PE2 | PE4 |
| | 85 | 5 | 5 | 5 | 20 | 1100 |

| | | | | |
|---|---|---|---|---|
| 6 | PE6 | PE3 | PE2 | PE4 |
| | 85 | 10 | 25 | 1100 |

| | | | | | |
|---|---|---|---|---|---|
| | 7 | PE2 | PE3 | PE2 | PE4 + Adh1/EVOH1/PE4 + adh1 |
| | | 30 | 60 | 30 | 525/50/525 |
| Reference | 1 | PE2 | PE3 | PE2 | PE4 |
| | | 30 | 60 | 30 | 1100 |
| | 2 | PE2 | PE3 | PE2 | PE4 |
| | | 30 | 60 | 30 | 1100 |

TABLE 2

| | | OTR of tube body | OTR of tube body | | | | Appearance |
|---|---|---|---|---|---|---|---|
| | | before folding | after folding | OTR of tube | WVTR of tube | Odor | of tube |
| | | (cc/m², day, atm) | (cc/m², day, atm) | (cc/tube, day, atm) | (g/tube, day) | evauation | body |
| Example | 1 | 0.3 | 0.50 | 0.032 | 0.0072 | A | C |
| | 2 | 0.15 | 0.25 | 0.030 | 0.0053 | A | B |
| | 3 | 0.1 | 0.14 | 0.026 | 0.0230 | A | A |
| | 4 | 0.14 | 0.22 | 0.290 | 0.0380 | B | B |
| | 5 | 0.09 | 0.12 | 0.024 | 0.0230 | A | A |
| | 6 | 0.11 | 0.15 | 0.025 | 0.0260 | B | A |
| | 7 | 0.11 | 0.13 | 0.006 | 0.0025 | A | A |
| Reference | 1 | 1.8 | 2.6 | 0.070 | 0.0100 | A | A |
| | 2 | 2.0 | 2.5 | 0.072 | 0.0150 | A | A |

TABLE 3

| | | | | | | | | | | | | | | Strucutre of |
|---|---|---|---|---|---|---|---|---|---|---|---|---|---|---|
| | | | | | Structure of body | | | | | | | | | shoulder |
| | | | | | Upper; material | | | | | | | | | Upper; material |
| | | | | | Lower; thickness | | | | | | | | | Lower; thickness |
| | | (outside) | | | (micron) | | | | | | (inside) | | | (micron) |
| Example | 8 | PE2 | PE3 | PE2 | lamina- | metalized | EVOH4 | adh1 | PE1 | lamina- | PE2 | PE3 | PE2 | PE4 |
| | | 30 | 60 | 30 | tion | — | 3 | 3 | 19 | tion | 30 | 60 | 30 | 1100 |
| | 9 | PE2 | PE3 | PE2 | lamina- | metalized | EVOH4 | adh1 | PE1 | lamina- | PE2 | PE3 | PE2 | PE4 |
| | | 30 | 60 | 30 | tion | uniaxially oriented | 3 | 3 | 19 | tion | 30 | 60 | 30 | 1100 |
| | 10 | PE2 | PE3 | PE2 | lamina- | metalized | EVOH5 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |
| | 11 | PE2 | PE3 | PE2 | lamina- | metalized | EVOH6 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |
| | 12 | PE2 | PE3 | PE2 | lamina- | metalized | EVOH7 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |
| | 13 | PE2 | PE3 | PE2 | lamina- | metalized | EVOH8 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |
| | 14 | PE2 | PE3 | PE2 | lamina- | metalized | EVOH9 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |
| | 15 | PE2 | PE3 | PE2 | lamina- | metalized | EVOH10 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |
| | 16 | PE2 | PE3 | PE2 | lamina- | metalized | EVOH11 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |
| | 17 | PE2 | PE3 | PE2 | lamina- | metalized | EVOH12 | adh2 | PP1 | lamina- | PE2 | PE3 | PE2 | PE4 |
| | | 30 | 60 | 30 | tion | biaxially oriented | 1 | 2 | 22 | tion | 30 | 60 | 30 | 1100 |

TABLE 4

| | | OTR of tube body | OTR of tube body | | | | Appearance |
|---|---|---|---|---|---|---|---|
| | | before folding | after folding | OTR of tube | WVTR of tube | Odor | of tube |
| | | (cc/m², day, atm) | (cc/m², day, atm) | (cc/tube, day. atm) | (g/tube, day) | evauation | body |
| Example | 8 | 0.14 | 0.18 | 0.027 | 0.0240 | A | A |
| | 9 | 0.11 | 0.12 | 0.025 | 0.0280 | A | A |
| | 10 | 0.08 | 0.12 | 0.025 | 0.0240 | A | A |
| | 11 | 0.08 | 0.12 | 0.026 | 0.0260 | A | A |
| | 12 | 0.08 | 0.12 | 0.025 | 0.0240 | A | A |
| | 13 | 0.08 | 0.12 | 0.025 | 0.0250 | A | B |
| | 14 | 0.09 | 0.15 | 0.026 | 0.0270 | B | B |
| | 15 | 0.08 | 0.12 | 0.025 | 0.0240 | B | A |
| | 16 | 0.15 | 0.24 | 0.030 | 0.0390 | B | A |
| | 17 | 0.17 | 0.28 | 0.032 | 0.0420 | C | B |

TABLE 5

| | | | | x1 + | x1/ | |
|---|---|---|---|---|---|---|
| | Croton | 2,4- | 2,4,6- | x2 + | (x2 + | x2 + |
| | aldehyde | Hexadienal | Octatrienal | x3 | x3) | 2*x3 |
| EVOH | ppm | ppm | ppm | ppm | — | ppm |
| EVOH1 | 0.20 | 0.00 | 0.00 | 0.20 | — | 0.00 |
| EVOH3 | 0.20 | 0.00 | 0.00 | 0.20 | — | 0.00 |
| EVOH4 | 0.60 | 0.06 | 0.02 | 0.68 | 7.5 | 0.10 |
| EVOH5 | 0.60 | 0.05 | 0.02 | 0.68 | 8.6 | 0.09 |
| EVOH6 | 0.50 | 0.12 | 0.08 | 0.70 | 2.5 | 0.28 |
| EVOH7 | 0.50 | 0.03 | 0.02 | 0.55 | 10.0 | 0.07 |
| EVOH8 | 0.50 | 0.01 | 0.00 | 0.51 | 50.0 | 0.01 |
| EVOH9 | 3.90 | 0.12 | 0.24 | 4.26 | 10.8 | 0.60 |
| EVOH10 | 3.90 | 0.03 | 0.00 | 3.93 | 130.0 | 0.03 |
| EVOH11 | 0.50 | 0.00 | 0.00 | 0.50 | — | 0.00 |
| EVOH12 | 4.10 | 0.50 | 0.10 | 4.70 | 6.8 | 0.70 |

1. A plastic tube comprising a body (A) and a shoulder (B), wherein
a. body (A) is a plastic film laminate with a total thickness of 200 to 500 μm comprising
i. a multilayer film (A1) comprising
1. an EVOH layer (a1) which is metalized or inorganic oxide coated on one surface,
2. a polyolefin layer (a2),
3. an adhesive layer (a3) between the surface of the EVOH layer (a1) which is not metalized or inorganic oxide coated and the polyolefin layer (a2), and
ii. a polyolefin film (A2) laminated to the metalized or inorganic oxide coated surface of the EVOH layer (a1), and wherein
b. the ethylene content of the EVOH in the EVOH layer (a1) is from 20 to 50 mol %,
c. the EVOH layer (a1) has a thickness of equal to or below 5 μm, and
d. the body (A) has an Oxygen Transmission Rate measured at 23° C. and 50% RH according to ISO21309-2 Annex C of below 0.5 cc/m², day, atm.

2. The plastic tube according to claim 1 wherein the multilayer film (A1) is uniaxially oriented with a stretching ratio of equal to or above 3.

3. The plastic tube according to claim 1 wherein the multilayer film (A1) is biaxially oriented with a stretching ratio of equal to or above 3 in both machine direction and transverse direction.

4. The plastic tube according to claim 1 wherein the melting point of the EVOH layer (a1) is equal to or below 150° C.

5. The plastic tube according to claim 1 wherein the EVOH layer (a1) comprises crotonaldehyde (X1) and 2,4-hexadienal (X2), and the content x1 of crotonaldehyde (X1) in the EVOH layer (a1) is 0.01 ppm or more and 4.0 ppm or less, and the content x2 of 2,4-hexadienal (X2) in the EVOH layer (a1) is 0.005 ppm or more and 0.65 ppm or less.

6. The plastic tube according to claim 5 wherein the EVOH layer (a1) optionally comprises 2,4,6-octatrienal (X3), and the sum (x1+x2+x3) is 7.0 ppm or less, wherein (x1) is the amount in ppm of crotonaldehyde (X1) in the EVOH layer (a1), (x2) is the amount in ppm of 2,4-hexadienal (X2) in the EVOH layer (a1), and (x3) is the amount in ppm of 2,4,6-octatrienal (X3) in the EVOH layer (a1).

7. The plastic tube according to claim 5 wherein x1/(x2+x3) is 2.0 or more and 150.0 or less, wherein (x1) is the amount in ppm of crotonaldehyde (X1) in the EVOH layer (a1), (x2) is the amount in ppm of 2,4-hexadienal (X2) in the EVOH layer (a1), and (x3) is the amount in ppm of 2,4,6-octatrienal (X3) in the EVOH layer (a1).

8. The plastic tube according to claim 5 wherein the sum (x2+2x3) of the content x2 (ppm) of 2,4-hexadienal (X2) and the content x3 (ppm) of 2,4,6-octatrienal (X3) by twice the content x3 (ppm) is 0.65 ppm or less.

9. The plastic tube according to claim 1 wherein the body (A) comprises a polyolefin layer (a5) comprising a post-consumer recycled polyolefin sandwiched between the polyolefin layer (a2) and an additional EVOH layer (a4).

10. The plastic tube according to claim 1 wherein the multilayer film (A1) is prepared by co-extrusion of the separate layers (a1) to (a3) and optional (a4) and (a5).

11. The plastic tube according to claim 1 wherein the shoulder (B) is a multilayer structure comprising an EVOH layer (b1) sandwiched between two polyolefin layers (b2) and (b3).

12. The plastic tube according to claim 11 wherein the shoulder (B) is a multilayer structure comprising adhesive layers between EVOH layer (b1) and polyolefin layer (b2) as well as between EVOH layer (b1) and polyolefin layer (b3).

13. Use of a plastic tube according to claim 1 in food, cosmetic or medical packaging applications.
